(19) United States
(12) Patent Application Publication
(10) Pub. No.: US 2025/0300157 A1
(43) Pub. Date: Sep. 25, 2025

(54) NOZZLE MEMBER AND DRYING DEVICE INCLUDING THE SAME

(71) Applicant: Samsung SDI Co., Ltd., Yongin-si (KR)

(72) Inventors: Gi Jong MOON, Yongin-si (KR); Jae Soon JANG, Yongin-si (KR)

(21) Appl. No.: 18/731,117

(22) Filed: May 31, 2024

(30) Foreign Application Priority Data
Mar. 25, 2024 (KR) 10-2024-0040409

(51) Int. Cl. H01M 4/04; H01M 4/23; H01M 10/058; H01M 50/249

(52) U.S. Cl. CPC H01M 4/0404; H01M 4/23; H01M 10/058; H01M 50/249; H01M 2220/20

(57) ABSTRACT

A nozzle member and a drying device for manufacturing a secondary battery. The nozzle member can uniformly dry even in regions where the width of the electrode plate changes by utilizing a number of nozzle parts having the same shape, and a drying device including the same. The nozzle member includes a number of nozzle parts spaced apart from each other, and each of the nozzle parts includes a frame; an inlet part connected to the frame and into which the dry material is configured to flow; a discharge part in contact with the frame and configured to discharge the dry material; and a flow part between the inlet part and the discharge part. The frame includes an insertion part, the inlet part is fixed to the frame, and the discharge part is movable.

### CROSS-REFERENCE TO THE RELATED APPLICATION

The present application claims priority to and the benefit of Korean Patent Application No. 10-2024-0040409, filed on Mar. 25, 2024, in the Korean Intellectual Property Office, the entire disclosure of which is incorporated herein by reference.

### BACKGROUND

### 1. Field

Embodiments relate to nozzle member and drying device including the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage).

The secondary battery includes a case, an electrode assembly, and an electrolyte. The electrode assembly includes a positive electrode plate, a negative electrode plate, and a separator. The separator is between the positive electrode plate and the negative electrode plate. The electrode assembly and the electrolyte are accommodated inside the case.

The positive electrode plate and the negative electrode plate each include an electrode plate and an active material layer on the electrode plate. The positive electrode plate includes a first electrode plate and a positive active material layer. The negative electrode plate includes a second electrode plate and a negative active material layer.

The positive active material layer and the negative active material layer are respectively coated on the electrode plates and then dried using a drying device. The electrode plates coated with the positive active material layer and the negative active material layer are dried by the drying device. Moisture or impurities on the active material layer may be removed by the drying process.

If the moisture or the impurities are not completely removed, the polarity of the electrode plate becomes irregular or defective, and thus rated energy may not be generated. Accordingly, the performance and life of the secondary battery may be reduced.

Additionally, the electrode plates may have different widths for each position due to manufacturing tolerances. Accordingly, since the drying process is not properly performed in one area of the electrode plate, moisture or impurities may remain. Accordingly, the performance of the secondary battery may be reduced.

The information disclosed in this section is provided only for enhancement of understanding of the background of the disclosure and therefore it may contain information that does not form the prior art.

### SUMMARY

Embodiments of the present disclosure relate to a drying device including a nozzle member for manufacturing a secondary battery that can simplify the drying process of an electrode plate.

Embodiments provide a nozzle member for manufacturing a secondary battery that can improve the efficiency of the drying process of an electrode plate and a drying device including the same.

A nozzle member according to the embodiment includes a number of nozzle parts spaced apart from each other, and each of the nozzle parts include a frame; an inlet part connected to the frame and into which a dry material is configured to flow; a discharge part in contact with the frame and configured to discharge the dry material; and a flow part between the inlet part and the discharge part. The frame includes an insertion part. The inlet part is fixed to the frame, and the discharge part is movable relative to the frame.

A drying device to one embodiment includes a chamber; a transfer part accommodated in the chamber and supporting an electrode plate; a distribution part accommodated in the chamber and on the transfer part; and a nozzle member under the distribution part and configured to distribute dry material from the distribution part.

### BRIEF DESCRIPTION OF THE DRAWINGS

The accompanying drawings, which are incorporated in this specification, illustrate embodiments and serve to further illustrate the technical ideas of the disclosure in conjunction with the detailed description of embodiments that follows, and the disclosure is not to be construed as limited to what is shown in such drawings. In the drawings:

FIG. 1 is a side view showing a drying device according to an embodiment.

FIG. 2 is a tope view showing a drying device according to the embodiment.

FIG. 3 is a view explaining the problems of the drying device according to the comparative example.

FIG. 4 is a partial perspective view showing the nozzle portion of the drying device according to the embodiment.

FIG. 5 is a sectional view showing the nozzle portion of the drying device according to the embodiment.

FIGS. 6 and 7 are top views showing the inlet portion and discharge portion of the nozzle portion of the drying device according to the embodiment.

FIGS. 8 and 9 are views explaining the movement of the discharge portion of the nozzle portion according to the embodiment.

FIG. 10 is a top view showing the nozzle portion and the discharge portion of the drying device according to the embodiment.

FIG. 11 is a sectional view showing the nozzle portion according to another embodiment.

FIGS. 12 and 13 are views explaining the movement of a second discharge portion of the nozzle portion according to another embodiment.

FIG. 14 is a sectional view showing the nozzle portion according to another embodiment.

FIGS. 15 and 16 are views explaining the movement of a shielding portion of the nozzle portion according to another embodiment.

FIG. 17 is a sectional view showing the nozzle portion according to another embodiment.

FIGS. 18 and 19 are views explaining the movement of a shielding portion of the nozzle portion according to another embodiment.

FIGS. 20 to 22 are views explaining various examples of secondary batteries manufactured using the drying device according to the embodiments.

FIGS. 23 and 24 are perspective views of a battery pack including a secondary battery according to the embodiments.

FIGS. 25 and 26 are perspective and side views of a vehicle including the battery pack according to the embodiments.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Hereinafter, a nozzle member and a drying device including the same according to an embodiment will be described with reference to the drawings. The nozzle member and the drying device described below are used when manufacturing a secondary battery. The nozzle member and the drying device may be used when manufacturing a negative electrode plate and a positive electrode plate of an electrode assembly. That is, the nozzle member and the drying device are used to manufacture the secondary battery. For example, the nozzle member and the drying device may be used to manufacture a lithium ion secondary battery.

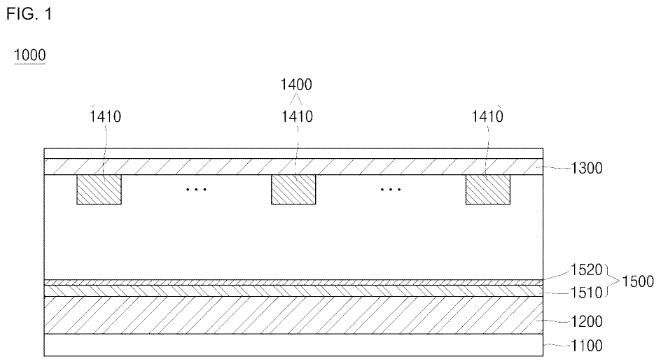

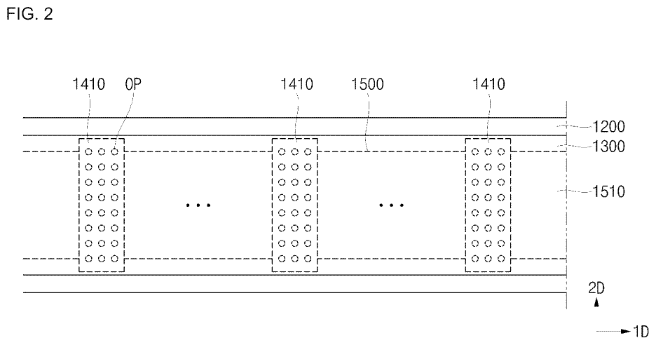

Referring to FIGS. 1 and 2, the drying device 1000 according to the embodiment includes a chamber 1100, a transfer part 1200, a distribution part 1300, and a nozzle member 1400.

The chamber 1100 accommodates the transfer part 1200, the distribution part 1300, and the nozzle member 1400. The inside of the chamber 1100 is maintained in a vacuum state.

The transfer part 1200 is in the chamber 1100. An electrode plate 1500 is on the transfer part 1200. The electrode plate 1500 includes am electrode current collecting plate 1510 and an electrode active material 1520 on the electrode current collecting plate 1510.

In one or more embodiments, a first electrode plate or a second electrode plate is on the transfer part 1200.

The first electrode plate may include a first electrode current collector plate and a first electrode active material on the first electrode current collector plate. The first electrode active material may be formed by coating on at least one surface of the first electrode current collector plate. The first electrode current collector plate may include a metal foil such as copper, a copper alloy, nickel, or a nickel alloy. The first electrode active material may include an electrode active material such as graphite or carbon. In one or more embodiments, the first electrode plate may be a negative plate.

The second electrode plate may include a second electrode current collector plate and a second electrode active material on the second electrode current collector plate. The second electrode active material may be formed by coating on at least one surface of the second electrode current collector plate. The second electrode current collector plate may include a metal foil such as aluminum or an aluminum alloy. The second electrode active material may include a transition metal oxide. In one or more embodiments, the second electrode plate above may be a positive plate.

An electrode assembly may be manufactured by positioning a separator between the first electrode plate and the second electrode plate. The separator is configured to prevent a short circuit between the first electrode plate and the second electrode plate and to allow the movement of lithium ions. In one or more embodiments, the separator may include a polyethylene film, a polypropylene film, or a polyethylene-polypropylene film.

The electrode assembly may be wound in a jelly-roll form. The electrode assembly may be inserted into a case together with an electrolyte to manufacture a secondary battery.

The first electrode plate and the second electrode plate are on the transfer part 1200. The transfer part 1200 includes a moving or moveable member. In one or more embodiments, the moving member may include a plurality of rollers. Accordingly, the first electrode plate and the second electrode plate after the drying process are completed may be moved to the next process step by the transfer part 1200.

The distribution part 1300 and the nozzle member 1400 are on the chamber 1100. In one or more embodiments, the distribution part 1300 and the nozzle member 1400 are on the transfer part 1200. In one or more embodiments, the distribution part 1300 and the nozzle member 1400 are on the electrode plate 1500.

The distribution part 1300 may be configured to distribute dry material to the nozzle member 1400. In one or more embodiments, the distribution part 1300 is connected to a supply part outside of the chamber 1100. The dry material is transferred from the supply part to the distribution part 1300. In addition, the dry material is distributed from the distribution part 1300 to the nozzle member 1400. The dry material includes a gaseous or liquid material. In one or more embodiments, the dry material may be a gas in a temperature range capable of removing moisture or impurities on the electrode plate 1500.

The nozzle member 1400 includes a plurality of nozzle parts 1410. In the illustrated embodiment, the nozzle member 1400 includes three nozzle parts. However, the present disclosure is not limited thereto. In one or more embodiments, the nozzle member 1400 may include less than or equal to three nozzle parts. In one or more embodiments, the nozzle member 1400 may include three or more nozzle parts. In one or more embodiments, the nozzle member 1400 may include eight to ten nozzle parts.

The nozzle parts 1410 are spaced apart from each other in a first direction 1D. The first direction 1D is a longitudinal direction of the electrode plate 1500. In one or more embodiments, the first direction 1D may be a moving direction of the electrode plate 1500.

Each nozzle part has a width in the first direction 1D. Also, each nozzle part has a length in a second direction 2D perpendicular to the first direction 1D. Also, the electrode plate 1500 has a length in the first direction 1D and a width in the second direction 2D.

Each of the nozzle parts 1410 includes a plurality of openings OP. The plurality of openings OP includes a plurality of first openings OP1 and a plurality of second openings OP2.

The first openings OP1 are on the nozzle part 1410. The first openings OP1 face the distribution part 1300. The first openings OP1 face the second openings OP2. The first openings OP1 are at an inlet of the nozzle part 1410.

The second openings OP2 are under the nozzle part 1410. The second openings OP2 face the first openings OP1. The second openings OP2 are at a discharge part of the nozzle part 1410.

The dry material distributed to each nozzle part 1410 by the distribution part 1300 is flowed into the inside (flow unit) of the nozzle part 1410 by the first openings OP1. Also, the dry material flowed into the nozzle part 1410 is moved toward the electrode plate 1500 by the second openings OP2.

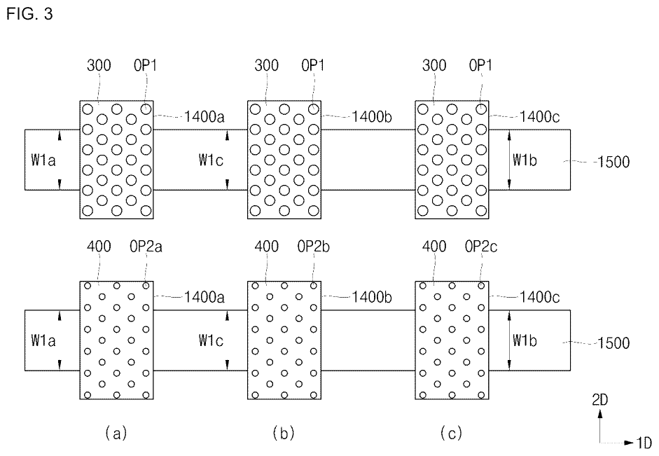

FIG. 3 is a view explaining a problem of a drying device according to a comparative example.

Referring to FIG. 3, the nozzle member 1400 is on the electrode plate 1500. The width of the electrode plate 1500 may vary in a first direction 1D. For example, a width W1a of one end of the electrode plate, a width w1b of the other end of the electrode plate, and a width w1c of the central (or intermediate) portion of the electrode plate may each be different. For example, the width of the electrode plate 1500 may increase or decrease from one end to the other end. Alternatively, the widths of one end and the other end of the electrode plate may be greater or less than the width of the central (or intermediate) portion.

The nozzle parts 1400a, 1400b, and 1400c include the inlet part 300 and the discharge part 400. The dry material is flowed into the nozzle part by the first openings OP1 of the inlet part 300. Subsequently, the dry material is moved to the electrode plate 1500 by the second openings OP2 of the discharge part 400.

When the second openings OP2 of the nozzle parts 1400a, 1400b, and 1400c are all formed at the same positions, the degree of drying may vary for each region of the electrode plate.

For example, when the width of the electrode plate 1500 varies, the overlapping area between the electrode plate and the second openings OP2 may vary for each region. Accordingly, a portion having a small overlapping area may have a smaller degree of drying than a portion having a large overlapping area. Accordingly, one region of the electrode plate is not dried as well as other regions, and moisture or impurities may remain in that portion. Accordingly, there may be a problem that the characteristics of the electrode plate are different for each region.

Additionally, when the width of the electrode plate varies, one end of the portion of the electrode plate having a narrow width in the width direction may barely overlap the second openings. Accordingly, the side portion of the portion of the electrode plate having a narrow width in the width direction is not dried as well as the other regions, and moisture or impurities may remain. Accordingly, there may be a problem in that the characteristics of the electrode plate are different for each region.

In order to solve the above problem, the second openings formed in discharge parts of the nozzle part may be formed differently at different positions. In this case, the nozzle member includes a plurality of nozzle parts having different positions of the second openings. That is, the first nozzle part 1400a, the second nozzle part 1400b, and the third nozzle part 1400c may have different positions of the second openings OP2 in the discharge part 400. Accordingly, the first nozzle part 1400a, the second nozzle part 1400b, and the third nozzle part 1400c must be individually manufactured.

Accordingly, nozzle parts having different shapes are required to drive the drying device. In addition, a process of replacing the nozzle parts may be required depending on the varying width of the electrode plate. Accordingly, process efficiency may be decreased and the process cost may be increased.

Embodiments of the present disclosure are configured to address these issues. To this end, the nozzle member according to one or more embodiments includes a nozzle part including a discharge part that is movable.

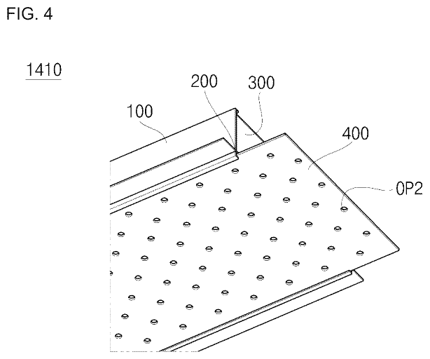

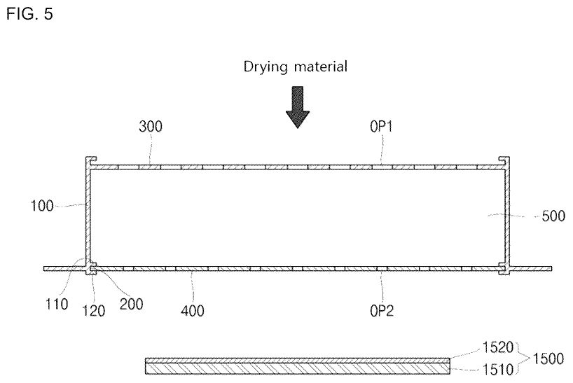

Referring to FIGS. 4 to 10, the nozzle part 1410 may include a frame 100, an insertion part 200, an inlet part 300, a discharge part 400, and a flow part 500.

The frame 100 supports the inlet part 300 and the discharge part 400. In one or more embodiments, the inlet part 300 and the discharge part 400 may be connected to or in contact with and supported by the frame 100.

The inlet 300 is connected to the frame 100. The inlet 300 is connected to one side surface of the frame 100. In one or more embodiments, the frame 100 and the inlet 300 are connected by welding. Accordingly, the inlet 300 may be fixedly connected the frame 100.

The discharge part 400 is under the inlet part 300. The inlet part 300 and the discharge part 400 face each other. The discharge part 400 is connected to the frame 100. The nozzle part 1410 includes the insertion part 200. In one or more embodiments, the frame 100 includes a plurality of extension parts 110 and 120 protruding in an inner direction of the nozzle part. The extension parts 110 and 120 are spaced apart from each other. Accordingly, the insertion part 200 is supported between the extension parts 110 and 120.

The discharge part 400 is in the insertion part 200. The discharge part 400 is movable in the insertion part 200. That is, the discharge part 400 contacts the frame 100, but they are not connected to each other by welding or other means. Accordingly, the discharge part 400 may be movable in the longitudinal direction of the nozzle part 1410. That is, the discharge part 400 may be movable in the width direction of the electrode plate 1500.

The inlet part 300 includes a plurality of first openings OP1. The discharge part 400 includes a plurality of second openings OP2. The flow part 500 is between the inlet part 300 and the discharge part 400. The flow part 500 is an empty space area between the inlet part 300 and the discharge part 400.

The distribution part 1300 is on the nozzle part 1410, and the dry material is flowed into the nozzle part 1410 by the distribution part 1300. In one or more embodiments, the dry material is flowed into the flow part 500 by the first openings OP1 in the inlet part 300. Since the dry material is introduced into the flow part 500 by a plurality of first openings OP1, the moving speed of the dry material may be increased. Accordingly, a drying process time may be reduced.

The dry material is diffused in the flow unit 500 and transferred to the electrode plate 1500 by the second openings OP2. Since the dry material moves to the electrode plate by a plurality of second openings OP2, the dry material moving to the electrode plate may be uniform (or substantially uniform) for each region of the electrode plate. Also, a moving speed of the dry material moving to the electrode plate may be controlled by controlling a size of the second openings OP2. In one or more embodiments, in a process in which the moving speed of the dry material is to be increased, the size of the second openings OP2 may be reduced. Also, in the process in which the moving speed of the dry material is to be reduced, the size of the second openings OP2 may be increased. That is, the moving speed of the dry material may be inversely proportional to the size (diameter) of the second openings OP2, and the moving speed of the dry material may be controlled by controlling the size of the second openings OP2.

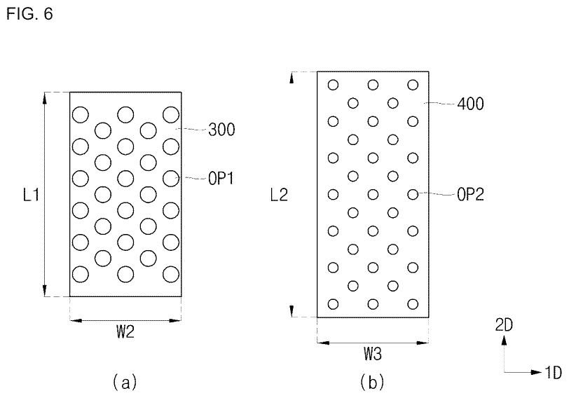

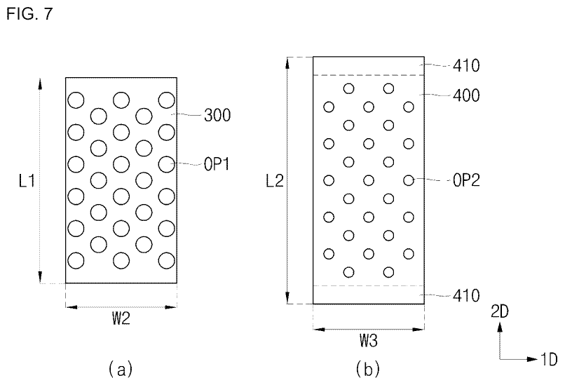

Referring to FIGS. 6 and 7, the first openings OP1 and the second openings OP2 may have different sizes. In one or more embodiment, the diameter of each of the first openings OP1 and the diameter of each of the second openings OP2 may be different. In one or more embodiments, the diameter of each of the first openings OP1 may be larger than the diameter of each of the second openings OP2.

The first openings OP1 are passages through which a dry material is flowed into the flow part 500. Accordingly, when the diameter of each of the first openings OP1 increases, the area into which the dry material may be flowed may increase. Thereby, the dry material may be more easily moved to the flow part 500.

The second openings OP2 are passages through which a drying material moves to an electrode plate. Accordingly, when the diameter of each of the second openings OP2 is reduced and the drying material moves to the electrode plate, the drying material may move quickly without changing temperature (or substantially without changing temperature).

In one or more embodiments, the diameter of each of the second openings OP2 may be approximately 15 mm or less. In one or more embodiments, the diameter of each of the second openings OP2 may be approximately 4 mm to approximately 15 mm, approximately 5 mm to approximately 13 mm, or approximately 6 mm to approximately 10 mm.

Although the first openings OP1 and the second openings OP2 have a circular shape, the present disclosure is not limited thereto. In one or more embodiments, the first openings OP1 and the second openings OP2 may have a polygonal shape such as an ellipse or a square.

The inlet part 300 and the discharge part 400 may have different sizes. In one or more embodiments, the width W2 of the inlet part 300 may be the same as or similar to the width W3 of the discharge part 400. The length L1 of the inlet part 300 may be different from the length L2 of the discharge part 400. In one or more embodiments, the length L2 of the discharge part 400 may be longer than the length L1 of the inlet part 300.

The discharge part 400 is movable relative to the frame 100 and the inlet part 300. Accordingly, the length of the discharge part 400 may be longer than the inlet part 300 by a size corresponding to a length in which the discharge part may be moved. Accordingly, the discharge part 400 may be configured to protrude outward from the frame in a direction in which the discharge part 400 moves.

Referring to FIG. 7, the discharge part 400 may include one or more closed regions 410. The closed region 410 may be located at both ends of the discharge part 400 in the longitudinal direction, respectively. The second openings OP2 are not in the closed region 410.

As described above, the discharge part 400 is movable relative to the frame 100. The discharge part 400 may be moved by transferring a force to the closed region 410. Because the second openings OP2 are not formed in the closed region, the second openings OP2 may be prevented from being deformed by the force. Also, because the area of the openings OP2 in the discharge unit 400 is reduced, the strength of the discharge unit 400 may be improved. Also, the drying material may be prevented from moving through the closed region 410 at the ends of the discharge unit 400, Thus, the loss of the drying material may be reduced.

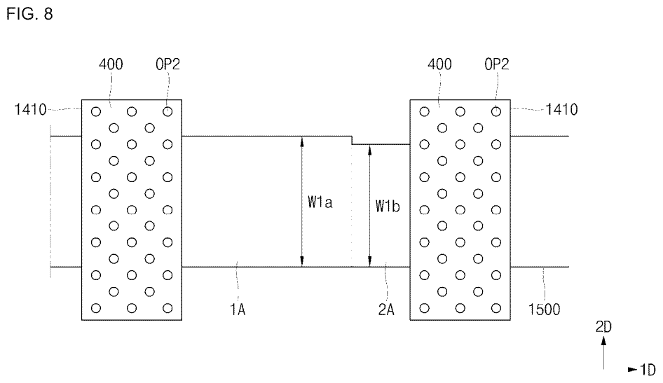

Referring to FIG. 8, a plurality of nozzle parts 1410 are on the electrode plate 1500. A plurality of nozzle parts 1410 have the same shape. In one or more embodiments, the discharge parts 400 of a plurality of nozzle parts 1410 have second openings OP2 formed at the same positions. The electrode plate 1500 may include regions having different widths. Accordingly, the electrode plate 1500 may include a first region 1A and a second region 2A having different widths. The width Wia of the first region 1A may be greater than the width W1b of the second region 2A.

Accordingly, an overlapping area between the first region 1A and the second openings OP2 and an overlapping area between the second region 2A and the second openings OP2 may be different. For example, the second openings OP2 are on both ends of the first region 1A in the width direction. However, the second openings OP2 are only partially on one end of the second region 2A in the width direction (i.e., the second openings OP2 partially overlap one end of the second region 2A in the width direction). Accordingly, the drying material moving to one end of the second region 2A may be reduced. Accordingly, drying of one end of the second region 2A may not be properly performed, and thus moisture or impurities may remain.

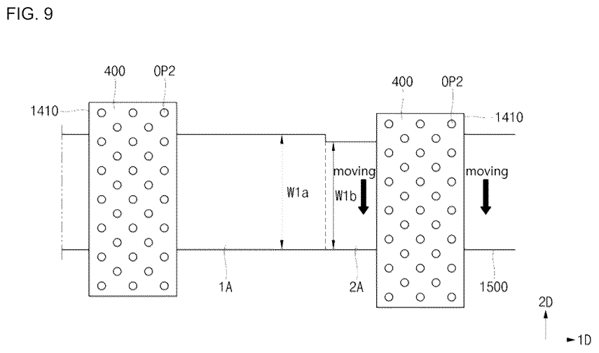

Referring to FIG. 9, the discharge part 400 on the second region 2A may move relative to the electrode plate 1500. In one or more embodiments, the discharge part 400 on the second region 2A may move in the width direction (direction 2D) of the electrode plate 1500. Accordingly, the second openings OP2 may be repositioned to be on both ends of the second region 2A in the width direction. Accordingly, since drying of both ends of the second region 2A may be completely performed, moisture or impurities may be prevented from remaining.

The nozzle member and the drying device according to the embodiment include a plurality of nozzle parts. The plurality of nozzle parts may all have the same shape. In one or more embodiments, the openings in the inlet part and discharge part of the nozzle parts may be in the same positions, have the same size, and be spaced apart from each other at the same interval.

In addition, the inlet part is fixed relative to the frame and the width direction of the electrode plate, and the discharge part is movable in the width direction of the electrode plate. Accordingly, even if the same nozzle part is used, a drying difference due to a difference in widths of the electrode plates may be prevented (or at least mitigated against). In one or more embodiments, the discharge part of the nozzle part may move in the width direction of the electrode plates depending on the difference in widths of the electrode plates. Accordingly, it is possible to prevent a drying difference due to a difference in widths of the electrode plates.

Accordingly, in the nozzle member and drying device according to the embodiment, a plurality of nozzle parts having the same configuration may be utilized instead of the related art system in which nozzle parts have different configuration depending on the varying widths of the electrode plate. In addition, even when drying an electrode plate where the location of the region where the width changes is different, the drying process may be performed using the same plurality of nozzle parts without replacing them with different nozzle parts.

Accordingly, the nozzle member and the drying device according to the embodiment may simplify the drying process of the electrode plate. In addition, the nozzle member and the drying device according to the embodiment may improve the drying process efficiency.

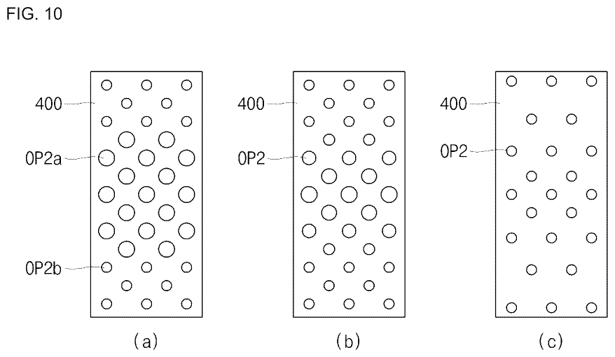

Referring to FIG. 10, the second openings OP2 may be configured to have various sizes and to be arranged at various intervals.

Referring to (a) of FIG. 10, the second openings OP2 may include an opening OP2a and an opening OP2b. The second the opening OP2a is in a central region in the longitudinal direction of the discharge part 400. The opening OP2b is in an outer region in the longitudinal direction of the discharge part 400. The opening OP2a may be larger than the opening OP2b.

Referring to (b) of FIG. 10, the second openings OP2 may include openings of various sizes. In one or more embodiments, the sizes of the second openings OP2 may decrease as they extend in a direction from the central region to the outer region of the discharge part 400 based on the longitudinal direction of the discharge part 400.

Referring to (c) of FIG. 10, the second openings OP2 may be arranged at various intervals. In one or more embodiments, the intervals between adjacent openings of the second openings OP2 may increase in a direction extending from the central region to the outer region of the discharge part 400 based on the longitudinal direction of the discharge part 400.

Accordingly, the density of the second openings OP2 may be greater in the central region of the discharge part 400 than in the outer region of the discharge part 400. The width of the electrode plate is smaller than the length of the discharge part 400. Accordingly, the electrode plate mostly overlaps the central region of the discharge part 400. Accordingly, by increasing the density of the second openings OP2 in the central region of the discharge part 400 overlapping with the electrode plate, the amount of dry material moving to the electrode plate may be increased. Accordingly, the efficiency of the drying process may be improved.

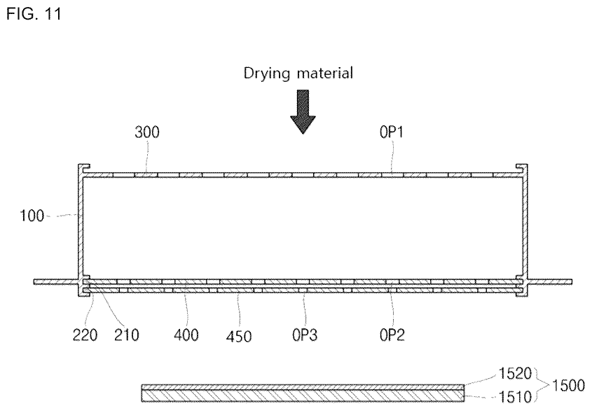

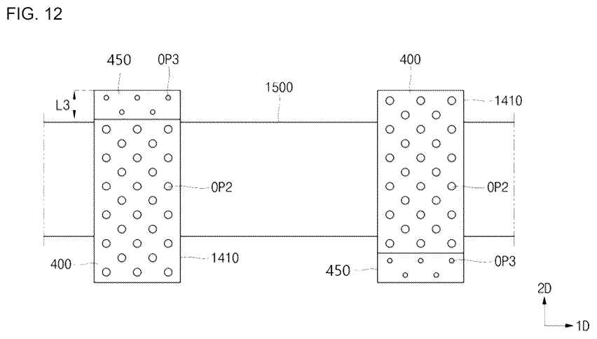

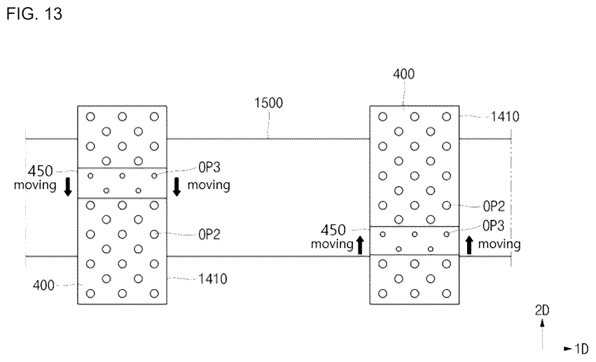

Hereinafter, a drying device according to another embodiment will be described with reference to FIGS. 11 to 13. The description of the drying device according to the above-described embodiment may be combined with the drying device according to other embodiments described below. In addition, description of the same configuration or the same components as the drying device according to the previously described embodiment will be omitted. In addition, the same reference numerals are assigned to the same components as the drying device according to the previously described embodiment.

Referring to FIGS. 11 to 13, the frame 100 may include a plurality of insertion parts. In one or more embodiments, the insertion part may include a first insertion part 210 and a second insertion part 220. The first insertion part 210 is between the inlet part 300 and the second insertion part 220.

The discharge part 400 may be inserted into the first insertion part 210. An auxiliary discharge part 450 may be inserted into the second insertion part 220. Accordingly, each of the discharge part 400 and the auxiliary discharge part 450 may be movable relative to the frame 100.

The auxiliary discharge part 450 may be on at least one end of the discharge part 400. The length L3 of the auxiliary discharge part 450 may be shorter than the length L2 of the discharge part 400.

The auxiliary discharge part 450 may include a plurality of third openings OP3. The third openings OP3 have a different size from both the first openings OP1 and the second openings OP2. In one or more embodiments, the diameter of each of the third openings OP3 may be different from the diameter of each of the first openings OP1 and the diameter of each of the second openings OP2. In one or more embodiments, the diameter of each of the third openings OP3 may be smaller than the diameter of each of the first openings OP1 and the diameter of each of the second openings OP2. In one or more embodiments, the diameter of each of the third openings OP3 may be larger than the diameter of each of the first openings OP1 and the diameter of each of the second openings OP2. In one or more embodiments, the diameter of each of the third openings OP3 may be between the diameter of each of the first openings OP1 and the diameter of each of the second openings OP2.

When using the drying device, the openings of the discharge part may be controlled depending on the drying process or the state of the electrode plate. For example, if more moisture or impurities remains in one region of the electrode plate than in another region, the one region requires more drying processes than the other region.

The auxiliary discharge part 450 may move in the width direction of the electrode plate. Accordingly, the auxiliary discharge part 450 may move to one region of the electrode plate. For example, when a large amount of moisture or impurities remains in one region of the electrode plate as described above, the auxiliary discharge part 450 may be moved to the region and a drying process may proceed. Because the third openings OP3 have a relatively small diameter, the movement speed of the dry material passing through the third openings OP3 increases. Therefore, moisture or impurities remaining in the region of the electrode plate may be easily removed.

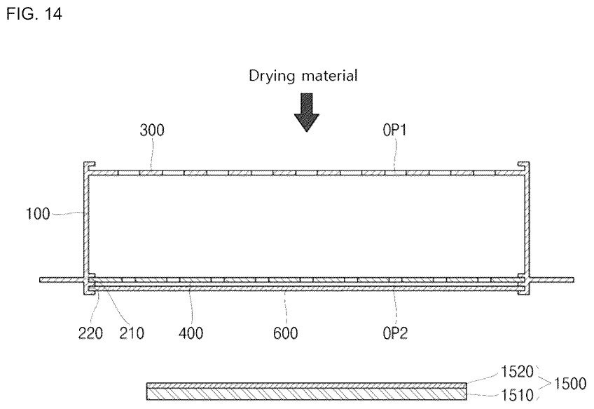

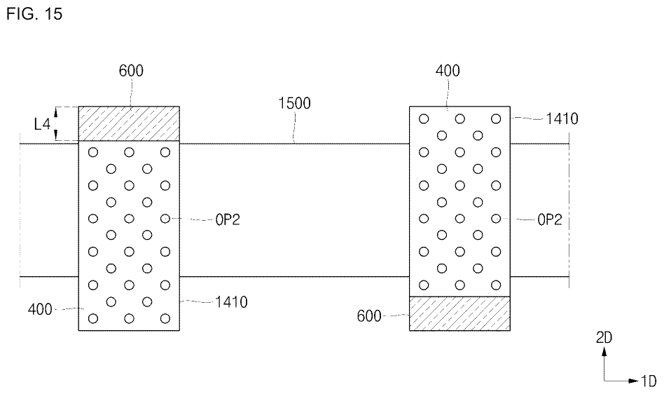

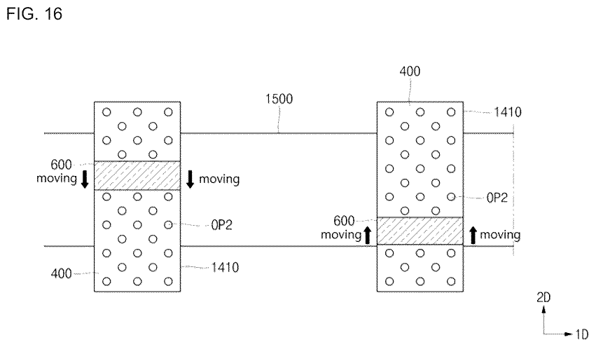

Hereinafter, a drying device according to another embodiment will be described with reference to FIGS. 14 to 16. The description of the drying device according to the above-described embodiment may be combined with the drying device according to other embodiments described below. In addition, description of the same configuration or components as the drying device according to the previously described embodiment will be omitted. In addition, the same reference numerals are assigned to the same components as the drying device according to the previously described embodiment.

Referring to FIGS. 14 to 16, the frame 100 may include a plurality of insertion parts. In one or more embodiments, the insertion part may include a first insertion part 210 and a second insertion part 220. The first insertion part 210 is between the inlet part 300 and the second insertion part 220.

The discharge part 400 may be inserted into the first insertion part 210. A shielding part 600 may be inserted into the second insertion part 220. Accordingly, each of the discharge part 400 and the shielding part 600 may be movable relative to the frame 100.

The shielding part 600 may be on at least one end of the discharge part 400. The length L4 of the shielding part 600 may be shorter than the length L2 of the discharge part 400.

The shielding part 600 does not include any openings.

When using the drying device, the opening of the discharge part may be controlled depending on the drying process or the state of the electrode plate. For example, if dry material concentrates in one region of the electrode plate, loss of the dry material may occur. Also, a situation may occur in which the second openings OP2 of the discharge part 400 must be closed.

The shielding part 600 may move in the width direction of the electrode plate. Accordingly, the shielding part 600 may move to one region of the electrode plate. In one or more embodiments, if a region where the second openings OP2 needs to be closed occurs as described above, the shielding part 600 may be moved to the region and a drying process may proceed.

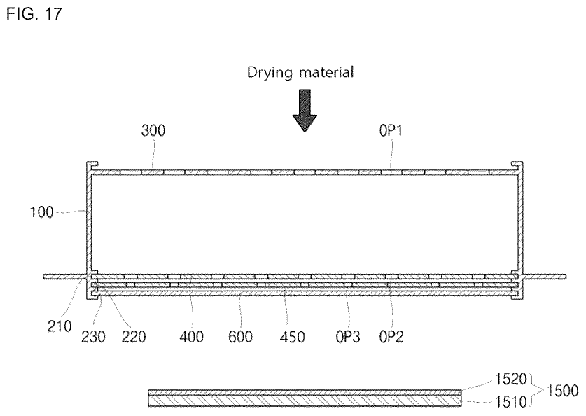

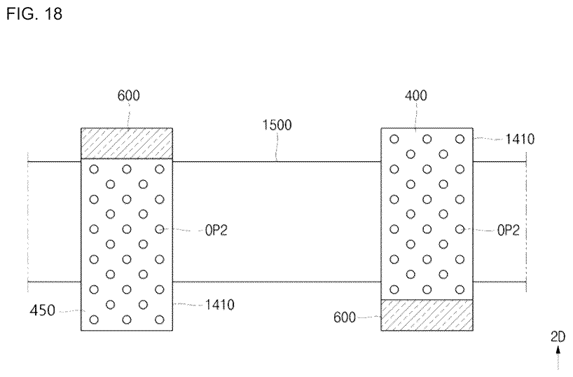

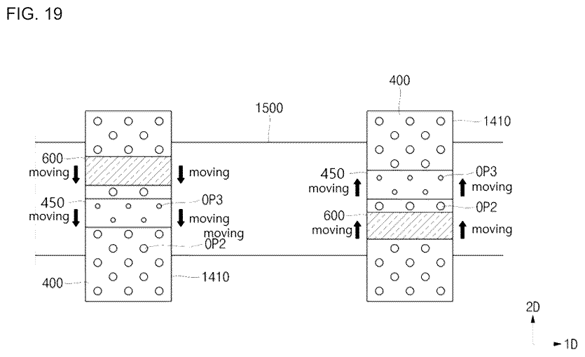

Hereinafter, a drying device according to another embodiment will be described with reference to FIGS. 17 to 19. The description of the drying device according to the above-described embodiment may be combined with the drying device according to other embodiments described below. In addition, description of the same configuration as the drying device according to the previously described embodiment will be omitted. In addition, the same reference numerals are assigned to the same components as the drying device according to the previously described embodiment.

Referring to FIGS. 17 to 19, the frame 100 may include a plurality of insertion parts. In one or more embodiments, the insertion part may include a first insertion part 210, a second insertion part 220, and a third insertion part 230. The first insertion part 210 is between the inlet part 300 and the second insertion part 220. The second insertion part 220 is between the first insertion part 210 and the third insertion part 230.

The discharge part 400 may be inserted into the first insertion part 210. The auxiliary discharge part 450 may be inserted into the second insertion part 220. The shielding part 600 may be inserted into the third insertion part 230. Accordingly, each of the discharge unit 400, the auxiliary discharge unit 500, and the shield 600 may be movable relative to the frame 100.

The auxiliary discharge part 450 and the shielding part 600 may be on at least one end of the discharge part 400. Additionally, the auxiliary discharge part 450 and the shielding part 600 may overlap each other.

When using the drying device, the opening of the discharge part may be controlled depending on the drying process or the state of the electrode plate. For example, if more moisture or impurities remains in one region of the electrode plate than in another region, the one region requires more drying processes than the other region.

The auxiliary discharge part 450 may move in the width direction of the electrode plate. Accordingly, the auxiliary discharge unit 450 may move to one region of the electrode plate. For example, when a large amount of moisture or impurities remains in one region of the electrode plate as described above, the auxiliary discharge part 450 may be moved to the region and a drying process may proceed. Since the third openings OP3 have a small diameter, the movement speed of the dry material passing through the third openings OP3 increases. Therefore, moisture or impurities remaining in the region may be easily removed.

The shielding part 600 does not include any openings.

When using the drying device, the opening of the discharge part may be controlled depending on the drying process or the state of the electrode plate. For example, if dry material concentrates in one region of the electrode plate, loss of the dry material may occur. Also, a situation may occur in which the second openings OP2 of the discharge part 400 must be closed.

The shielding part 600 may move in the width direction of the electrode plate. Accordingly, the shielding part 600 may move to one region of the electrode plate. In one or more embodiments, if a region where the second openings OP2 needs to be closed occurs as described above, the shielding part 600 may be moved to the region and a drying process may proceed.

That is, this embodiment controls the diameter size of the openings of the discharge part or closes at least some of the openings. Therefore, the efficiency of the drying process can be improved.

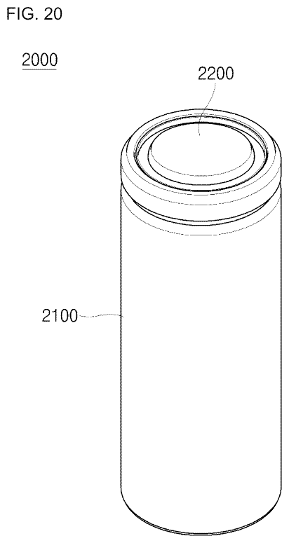

FIGS. 20 to 22 are views showing examples of secondary batteries manufactured using the nozzle member and drying device described above.

Referring to FIGS. 20 to 22, the secondary battery may be formed in various shapes.

Referring to FIG. 20, the secondary battery may include a cylindrical case 2100 and a cap plate 2200 that seals the case 2100. That is, the secondary battery may be a cylindrical secondary battery. The electrode assembly manufactured using the nozzle member and the drying device may be inserted into the case 2100 and sealed by the cap plate 2200.

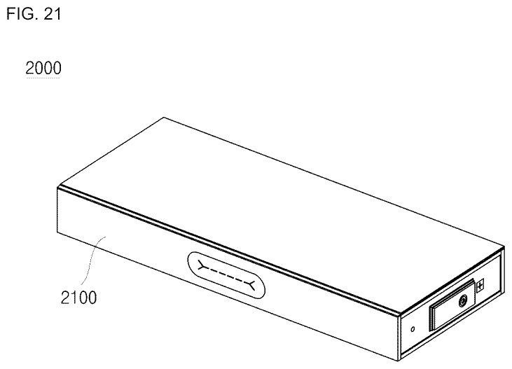

Referring to FIG. 21, the secondary battery may include a prismatic case 2100 and an electrode assembly accommodated inside the case. The electrode assembly may be manufactured using the nozzle member and the drying device according to an embodiment described above. The secondary battery may be a prismatic secondary battery.

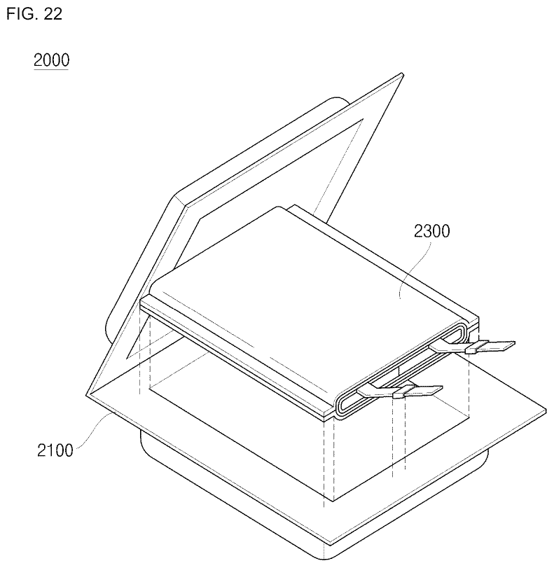

Referring to FIG. 22, the secondary battery may include a pouch-shaped case 2100. The case 2100 includes a receiving portion. The electrode assembly 2300 manufactured using the nozzle member and the drying device may be accommodated in the receiving portion. The secondary battery may be a pouch secondary battery.

The secondary battery according to the previously described embodiment may be used to manufacture a battery pack.

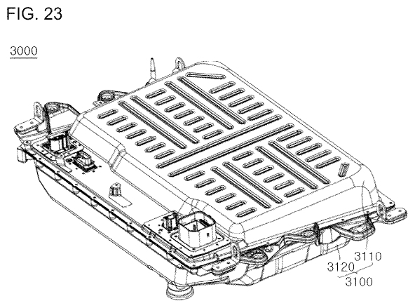

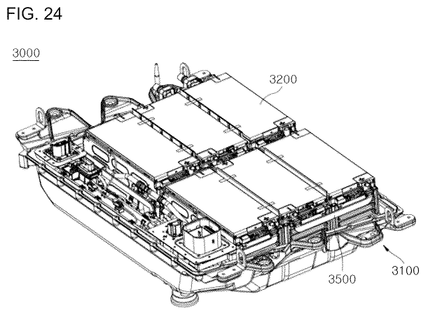

FIGS. 23 and 24 show a battery pack 3000 according to one or more embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar 251, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of battery cells are omitted. In one or more embodiments, battery pack 3300 may be mounted in a vehicle. The vehicle may be, for example, an electric vehicle, a hybrid vehicle, or a plug-in hybrid vehicle. A vehicle may include a four-wheeled vehicle or a two-wheeled vehicle.

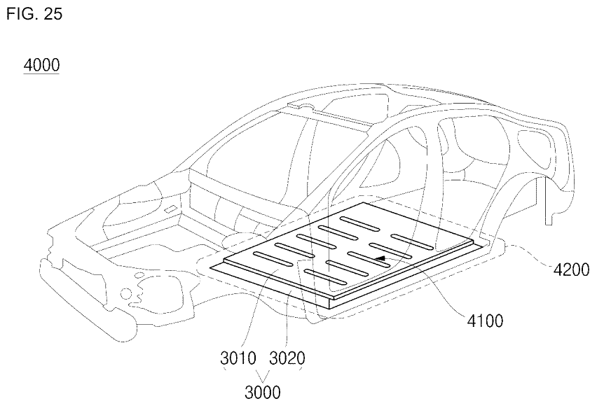

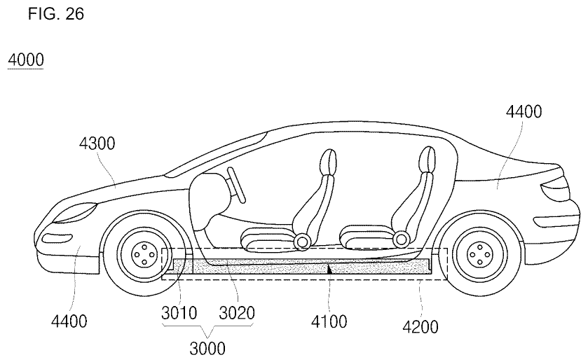

FIGS. 25 and 26 show vehicle body parts and vehicle 4000 according to one or more embodiments of the present disclosure including the battery pack 3000 shown in FIGS. 23 and 24.

In FIG. 25, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be integrally formed with a vehicle floor 4200. The vehicle underbody 4100 separates the inside and outside of a vehicle, and the pack frame 3020 may be disposed outside the vehicle.

In FIG. 26, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The nozzle member and the drying device according to the embodiment include a plurality of nozzle parts. The plurality of nozzle parts are all formed in the same shape. In detail, the openings formed in the inlet and discharge parts of the nozzle part are formed at the same location with the same size and interval.

Also, the inlet part is disposed to be fixed, and the discharge part is moveably disposed in the width direction of the electrode plate. Accordingly, even if the same nozzle part is used, drying differences due to differences in the widths of the electrode plates may be prevented. In detail, considering the difference in width of the electrode plate, the discharge part of the nozzle part may move in the width direction of the electrode plate. As a result, drying differences due to differences in widths of the electrode plates may be prevented.

Accordingly, in the nozzle member and drying device according to the embodiment, a plurality of nozzle parts having the same shape may be disposed without disposing nozzle parts of other shapes on a region where the width of the electrode plate changes. In addition, even when drying an electrode plate where the location of the region where the width changes is different, the drying process may be performed using the same plurality of nozzle parts without replacing them with different nozzle parts.

Accordingly, the nozzle member and the drying device according to the embodiment may simplify the drying process of the electrode plate. In addition, the nozzle member and the drying device according to the embodiment may improve the drying process efficiency.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure as claimed in the following claims.

What is claimed is:

1. A nozzle member comprising:
a plurality of nozzle parts spaced apart from each other, wherein each nozzle part of the plurality of nozzle parts comprises:
a frame;
an inlet part connected to the frame and into which a dry material is configured to flow;
a discharge part in contact with the frame, the discharge part being configured to discharge the dry material; and
a flow part between the inlet part and the discharge part,
wherein the frame comprises an insertion part,
wherein the inlet part is fixed to the frame, and
wherein the discharge part is movable relative to the frame.

2. The nozzle member as claimed in claim 1, wherein a length of the discharge part is longer than a length of the inlet part.

3. The nozzle member as claimed in claim 1, wherein the inlet part comprises a plurality of first openings,
wherein the discharge part comprises a plurality of second openings,
wherein a size of each of the plurality of first openings is larger than a size of each of the plurality of second openings.

4. The nozzle member as claimed in claim 3, wherein the discharge part comprises a closed region,
wherein the plurality of second openings is not in the closed region.

5. The nozzle member as claimed in claim 3, wherein sizes of the plurality of second openings decrease in a direction extending from a central region of the discharge part to an outer region of the discharge part.

6. The nozzle member as claimed in claim 3, wherein an interval between adjacent second openings of the plurality of second openings increases in a direction from a central region of the discharge part to an outer region of the discharge part.

7. The nozzle member as claimed in claim 3, wherein the insertion part comprises a first insertion part and a second insertion part,
wherein the first insertion part is between the inlet part and the second insertion part,
wherein the discharge part is in the first insertion part,
wherein an auxiliary discharge part is in the second insertion part,
wherein a length of the auxiliary discharge part is smaller than a length of the discharge part,
wherein the auxiliary discharge part comprises a plurality of third openings,
wherein a size of each of the plurality of third openings is different from the size of each of the plurality of first openings and the size of each of the plurality of second openings,
wherein the auxiliary discharge part is movable.

8. The nozzle member as claimed in claim 1, wherein the insertion part comprises a first insertion part and a second insertion part,
wherein the first insertion part is between the inlet part and the second insertion part,
wherein the discharge part is in the first insertion part,
wherein a shielding part is in the second insertion part,
wherein a length of the shielding part is smaller than the length of the discharge part,
wherein the shielding part is movable.

9. The nozzle member as claimed in claim 3, wherein the insertion part comprises a first insertion part, a second insertion part, and a third insertion part,
wherein the first insertion part is between the inlet part and the second insertion part,
wherein the second insertion part is between the first insertion part and the third insertion part,
wherein the discharge part is in the first insertion part,
wherein an auxiliary discharge part is in the second insertion part,
wherein a shielding part is in the third insertion part,
wherein a length of the auxiliary discharge part and the shielding part is smaller than a length of the discharge part,
wherein the auxiliary discharge part comprises a plurality of third openings,
wherein a size of each of the plurality of third openings is different from the size of each of the plurality of first openings and the size of each of the plurality of second openings,
wherein the auxiliary discharge part and the shielding part are movable.

10. The nozzle member as claimed in claim 1, wherein the each nozzle part is configured to deliver dry material to an electrode plate,
wherein discharge part is movable in a width direction of the electrode plate.

11. A drying device comprising;
a chamber;
a transfer part accommodated in the chamber and configured to support an electrode plate;
a distribution part accommodated in the chamber and on the transfer part; and
the nozzle member of claim 1, wherein the nozzle member is under the distribution part and is configured to distribute the dry material from the distribution part.

12. The drying device as claimed in claim 11, wherein the nozzle part has a width in a first direction and a length in a second direction perpendicular to the first direction,
wherein the electrode plate has a length in the first direction and a width in the second direction, and
wherein a length of the nozzle part is greater than the width of the electrode plate.

13. The drying device as claimed in claim 12, wherein the plurality of nozzle parts is spaced apart in the first direction,
wherein at least one of the discharge part, an auxiliary discharge unit, or a shielding part is configured to move in the second direction.
